(19) United States
(12) Patent Application Publication
(10) Pub. No.: US 2018/0103413 A1
(43) Pub. Date: Apr. 12, 2018

(54) DYNAMIC ASSIGNMENT OF REGIONAL NETWORK SETTINGS

(71) Applicant: GM GLOBAL TECHNOLOGY OPERATIONS LLC, Detroit, MI (US)

(72) Inventors: Eric T. Hosey, Royal Oak, MI (US); Russell A. Patenaude, Macomb Township, MI (US); David M. George, Farmington Hills, MI (US)

(21) Appl. No.: 15/289,486

(22) Filed: Oct. 10, 2016

(51) Int. Cl. H04W 48/04; H04W 4/02; H04W 8/20; H04B 1/3822

(52) U.S. Cl. CPC H04W 48/04; H04B 1/3822; H04W 8/205; H04W 4/025

(57) ABSTRACT

A system and method of dynamically selecting regional network settings at a wireless device includes: determining a geographic location or a wireless carrier system identifier at the wireless device; accessing, at the wireless device, a database of regional network settings associated with geographic locations or wireless carrier system identifiers; selecting one or more regional network settings at the wireless device based on the determined geographic location or wireless carrier system identifier via a search of the database of regional network settings; and wirelessly transmitting the selected regional network setting(s) to a cell tower of a wireless carrier system.

### TECHNICAL FIELD

The present invention relates to wireless telephony and, more particularly, to the manner in which regional network settings, used by wireless telephony devices, are assigned.

### BACKGROUND

Wireless telephony devices are used with wireless carrier systems to provide wireless telephony service. The wireless telephony devices, or wireless devices for short, can establish a packetized data connection through the wireless carrier system and provide regional network settings as part of establishing this connection. Often, the regional network settings are assigned to the wireless device based on its home wireless carrier. The wireless carrier system can identify the regional network settings it receives and establish a data connection, route packetized data, or both based on the identity of the regional network settings. Wireless devices are configured to use fixed regional network settings when establishing packetized data connections. That is, regardless of wireless device location or which wireless carrier system the wireless device is presently using, the wireless device uses the same regional network settings.

Wireless device manufacturers generally identify the area in which the wireless devices will be used or sold and program the devices with fixed regional network settings based on that information. However, this involves maintaining separate inventory for each geographical area where the wireless devices will be sold in for each wireless carrier system that operates as the home network for the devices. Apart from inventory logistics, a wireless device that uses fixed regional network settings and has travelled a significant distance from its original point of sale can unnecessarily route packetized data over long distances resulting in latencies experienced by the user or additional airtime costs. For example, a wireless device programmed with fixed regional network settings optimized for a wireless carrier system in the United States may be carried overseas to Europe. When the wireless device registers with a European wireless carrier system, the United States-based regional network settings may route packetized data sent and received by the wireless device overseas through a United States-based wireless carrier associated with the United States-based regional network settings.

### SUMMARY

According to an embodiment of the invention, there is provided a method of dynamically selecting regional network settings at a wireless device. The method includes determining a geographic location or a wireless carrier system identifier at the wireless device; accessing, at the wireless device, a database of regional network settings associated with geographic locations or wireless carrier system identifiers; selecting one or more regional network settings at the wireless device based on the determined geographic location or wireless carrier system identifier via a search of the database of regional network settings; and wirelessly transmitting the selected regional network setting(s) from the wireless device to a cell tower of a wireless carrier system.

According to another embodiment of the invention, there is provided a method of dynamically selecting regional network settings at a wireless device. The method includes determining a geographic location or a wireless carrier system identifier at the wireless device; wirelessly transmitting the geographic location or the wireless carrier system identifier from the wireless device to a central facility that maintains a database of regional network settings; receiving at the wireless device from the central facility one or more regional network settings that have been selected based on the determined geographic location or wireless carrier system identifier via a search of the database of regional network settings; and wirelessly transmitting the regional network setting(s) received at the wireless device to a cell tower of a wireless carrier system.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of dynamically determining an Access Point Name (APN).

### DETAILED DESCRIPTION OF THE ILLUSTRATED EMBODIMENTS

The system and method described below dynamically determines an regional network settings at a wireless telephony device based on the location of the device or the identity of the wireless carrier system the wireless telephony device contacts. The regional network settings can include a variety of cellular settings used by a cellular mobile network carrier including an Access Point Name (APN) identified by a text-based name or one or more other settings used to control interactions between a wireless carrier system, such as a mobile network carrier, and wireless telephony devices. The APN identifies the gateway through which the wireless telephony device connects to the Internet or other land networks and can be used based on the wireless carrier system or location. The regional network settings can include information useful for the wireless telephony device to establish communications with a particular wireless carrier system or in a particular geographic area. These settings can include voice fallback numbers, SMS short codes, Universal Resource Identifiers (URIs), and a Preferred Roaming List (PRL), to name a few.

A database of regional network settings that are identifiable by a geographic location, a wireless carrier system, or both can be maintained and accessed to determine appropriate regional network settings to be used. The wireless telephony device, also referred to more simply as a wireless device, is mobile and can determine its location or the identity of the wireless carrier system the wireless device is communicating with. The wireless telephony device can maintain the regional network settings database and search for regional network settings in the database that corresponds to the location, wireless carrier identity, or both. The wireless device can then select one or more regional network settings from the database and wirelessly transmit the selected regional network setting(s) to the wireless carrier system it is communicating with. Alternatively, a central facility can maintain the regional network settings database and receive the geographic location or identity of the wireless carrier system from the wireless device, identify one or more appropriate regional network settings based on that information, and send the regional network setting(s) to the wireless device. This dynamic selection of regional network settings obviates the need to maintain different inventories of wireless devices based on the fixed regional network settings the devices are configured to use. Also, the selection of regional network settings based on location, wireless carrier system, or both can facilitate more efficient routing of packetized data regardless of wireless device location.

### Communications System—

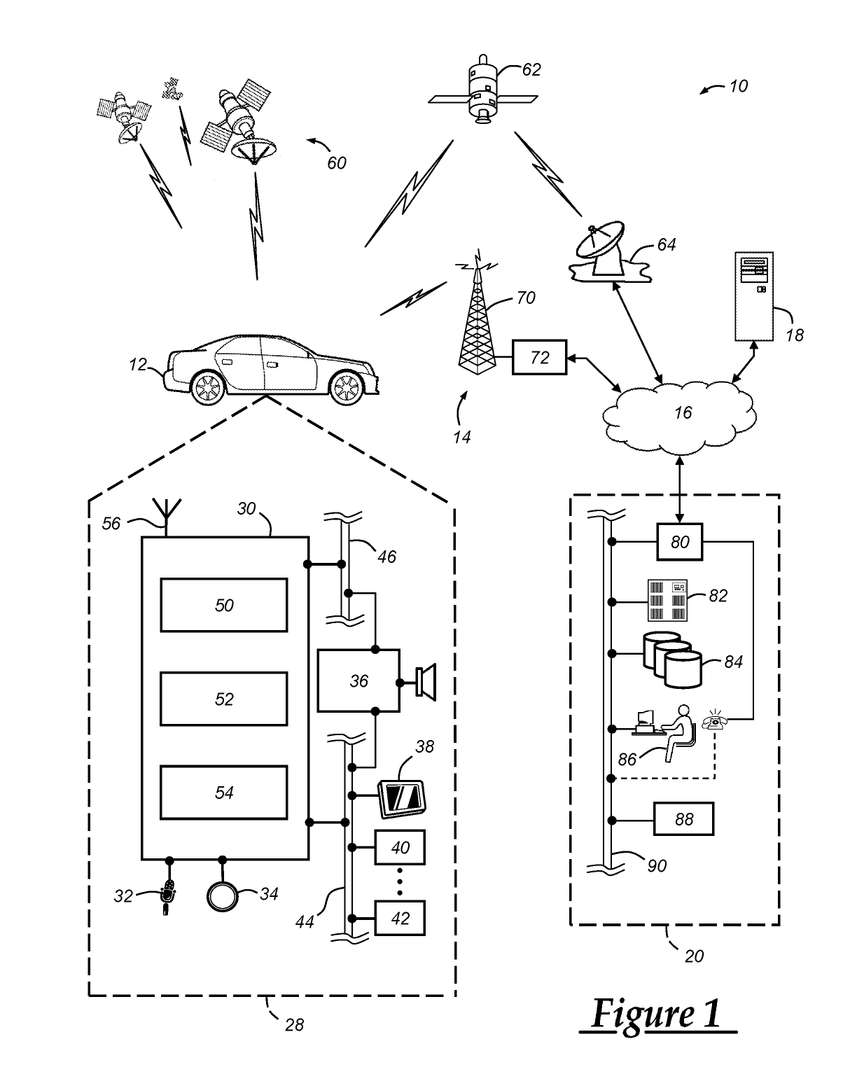

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and a type of wireless telephony device that can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

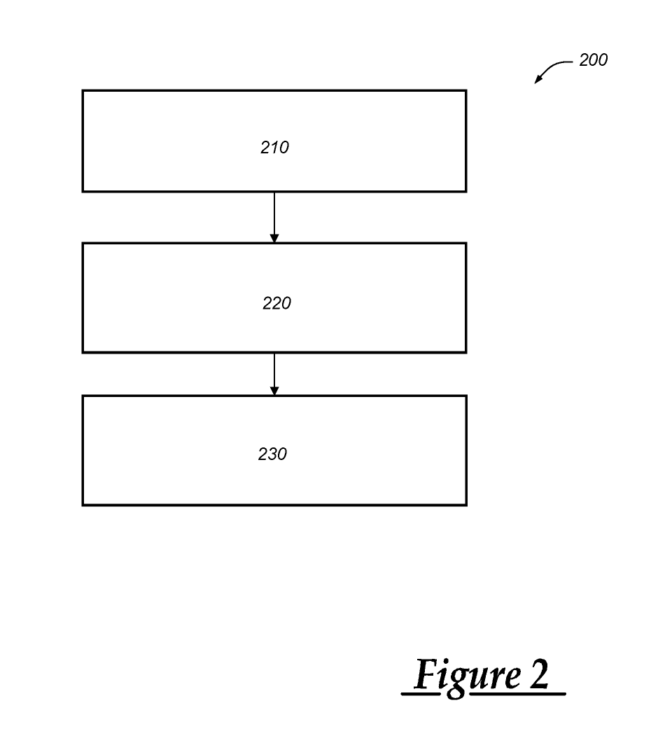

Turning now to FIG. 2, there is shown a method (200) of dynamically selecting regional network settings at a wireless telephony device. The method 200 begins at step 210 by determining a geographic location or a wireless carrier system identifier at the vehicle telematics unit 30. In this particular implementation, the wireless telephony device is implemented using the vehicle telematics unit 30 described above with respect to FIG. 1. But it should be understood that the described methods can also be implemented using other wireless telephony devices, such as handheld cellular phones or other handheld wireless devices that communicate with the wireless carrier system 14. The vehicle telematics unit 30 can determine its location in the form of latitude and longitude coordinates that can be generated using the GPS module 40. The processor 52 of the vehicle telematics unit 30 can provide the latitude and longitude coordinates to a map-matching software module that identifies the country, state, or other similar governmentally-defined boundary that indicates the location of the vehicle 12.

Location of the vehicle telematics unit 30 can also be determined based on information broadcast by the cell tower 70 of the wireless carrier system 14. The cell tower 70 can locally broadcast a mobile country code (MCC) indicating the country where the cell tower 70 is located. For example, the vehicle telematics unit 30 can broadcast the MCC 310 to indicate that the cell tower 70 is located in the United States, 334 when the cell tower 70 is located in Mexico, or 208 when the cell tower 70 is in France. Many more codes exist, which are defined by the International Telecommunications Union (ITU).

Apart from location, the vehicle telematics unit 30 can identify the wireless carrier system 14 it communicates with based on a wireless carrier system identifier. The cell tower 70 may broadcast a mobile network code (MNC) or what alternatively may be called a system identifier (SID) or network identifier (NID) that identifies the particular wireless carrier system 14 operating the cell tower 70. The MNC may be broadcast by the cell tower 70 along with the MCC. Using the examples above, the vehicle telematics unit 30 could receive a MCC/MNC pair of 310/006 indicating that Verizon operates the cell tower 70 in the United States. Or the vehicle telematics unit 30 could receive a MCC/MNC pair of 334/050 indicating that AT&T operates the cell tower 70 in Mexico. When the vehicle telematics unit 30 is ultimately delivered to a particular geographic location after manufacture, the unit 30 can be initially provisioned and then identify the MCC/MNC of the cell tower 70 it detects. The method 200 proceeds to step 220.

At step 220, a database of regional network settings associated with geographic locations or wireless carrier system identifiers is accessed and one or more regional network settings are selected based on the determined geographic location or wireless carrier system identifier via a search of the database. The database of regional network settings can include names of APNs that are each associated with a country, state, or governmentally-defined boundary, an MCC, or a wireless carrier system. One example of an APN is the text string “OnStar01.” This APN may be stored in the regional network settings database with the MCC 310 indicating the APN is used in the U.S. and one or more MNC codes identifying AT&T as the wireless carrier system 14 the APN is associated with. Other APNs that are associated with different countries and different wireless carrier systems can be stored in the regional network settings database as well. In another example, APN “OnStar01.mx” can be stored with MCC 334 and MNCs associating the APN with a wireless carrier system operated by Telefonica. And in yet another example, APN “OnStar01.eu” can be associated with a plurality of countries in Europe and a single wireless carrier system, such as Deutsche Telecom.

Apart from, or in addition to, identifying location based on MCC, the regional network settings database may used a geofenced boundary for each APN that may be defined by ranges of latitude and longitude coordinates. A search for an APN in the regional network settings database can be conducted using a latitude and longitude pair provided to the regional network settings database and APNs associated with geofenced boundaries the latitude and longitude pair lies within can be returned as search query results. The regional network settings database can include APNs that are used in every country on earth that offers cellular telephony.

In one implementation, the database of regional network settings can be maintained at the vehicle telematics unit 30, which may access the regional network settings database and search for APNs using criteria including geographic location, MCC, wireless carrier system identity, or any combination of these. The regional network settings database can be stored in memory device 54 and operated using the processor 52. In another implementation, the regional network settings database can be maintained at a remote facility, such as the computer 18 or call center 20. The vehicle telematics unit 30 can wirelessly transmit the geographic location or the identity of the wireless carrier system to the central facility. For instance, the vehicle telematics unit 30 can send an MCC and a wireless carrier system identifier to the call center 20 via the wireless carrier system 14. The call center 20 can operate and maintain the regional network settings database using servers 82 and databases 84. The call center 20 can provide the received MCC and wireless carrier system identifier, possibly in the form of an MNC, to the regional network settings database and receive in return from the regional network settings database the APN(s) that are associated in the database with the provided MCC and MNC. The call center 20 can then send an APN that has been selected based on the determined geographic location and/or wireless carrier system identifier via a search of the database of regional network settings.

The search for APNs in the regional network settings database can yield one or more APNs that meet the criteria provided. The vehicle telematics unit 30 can then select one of the APNs that were identified in the search. In one example, after vehicle telematics unit 30 searches the regional network settings database for APNs associated with the MCC 310, the vehicle telematics unit 30 may receive a number of APNs that relate to MCC 310 but have different MNCs. The vehicle telematics unit 30 can then identify its home wireless carrier system and select one of the APNs based on an MNC that matches an MNC belonging to the home wireless carrier system. While the method 200 is described in terms of an APN as a regional network setting, it should be understood that different regional network settings could be used instead of or in addition to the APN. The method 200 proceeds to step 230.

At step 230, the selected regional network setting(s) are wirelessly transmitted to the cell tower 70 of the wireless carrier system 14. In this example, the vehicle telematics unit 30 sends the selected APN to the wireless carrier system 14 as part of establishing a packet data connection. The wireless carrier system 14 can use the APN to control a plurality of regional network settings used to send packetized data between the vehicle telematics unit 30 and a remote node, such as a computer using the Internet or the call center 20. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of dynamically selecting regional network settings at a wireless device, comprising the steps of:
(a) determining a geographic location or a wireless carrier system identifier at the wireless device;
(b) accessing, at the wireless device, a database of regional network settings associated with geographic locations or wireless carrier system identifiers;
(c) selecting one or more regional network settings at the wireless device based on the determined geographic location or wireless carrier system identifier via a search of the database of regional network settings; and
(d) wirelessly transmitting the selected regional network setting(s) from the wireless device to a cell tower of a wireless carrier system.

2. The method of claim 1, wherein the geographic location comprises a latitude and longitude pair.

3. The method of claim 1, wherein the geographic location comprises a mobile country code (MCC).

4. The method of claim 1, wherein the wireless carrier system identifier comprises a mobile network code (MNC).

5. The method of claim 1, wherein the wireless device comprises a vehicle telematics unit.

6. The method of claim 1, wherein the database of regional network settings includes one or more Access Point Names (APNs) each associated with one geographic location and a plurality of wireless carrier system identifiers.

7. The method of claim 1, wherein the database of regional network settings includes one or more Access Point Names (APNs) each associated with a plurality of geographic locations and one wireless carrier system identifier.

8. The method of claim 1, wherein the database of regional network settings is maintained at the wireless device.

9. A method of dynamically selecting regional network settings at a wireless device, comprising the steps of:
(a) determining a geographic location or a wireless carrier system identifier at the wireless device;
(b) wirelessly transmitting the geographic location or the wireless carrier system identifier from the wireless device to a central facility that maintains a database of regional network settings;
(c) receiving at the wireless device from the central facility one or more regional network settings that have been selected based on the determined geographic location or wireless carrier system identifier via a search of the database of regional network settings; and
(d) wirelessly transmitting the regional network setting(s) received at the wireless device to a cell tower of a wireless carrier system.

10. The method of claim 9, wherein the geographic location comprises a latitude and longitude pair.

11. The method of claim 9, wherein the geographic location comprises a mobile country code (MCC).

12. The method of claim 9, wherein the wireless carrier system identifier comprises a mobile network code (MNC).

13. The method of claim 9, wherein the wireless device comprises a vehicle telematics unit.

14. The method of claim 9, wherein the database of regional network settings includes one or more Access Point Names (APNs) each associated with one geographic location and a plurality of wireless carrier system identifiers.

15. The method of claim 9, wherein the database of regional network settings includes one or more Access Point Names (APNs) each associated with a plurality of geographic locations and one wireless carrier system identifier.

16. The method of claim 9, wherein the database of regional network settings includes one or more Access Point Names (APNs) each associated with a universal resource indicator (URI).
